(19) United States
(12) Patent Application Publication
(10) Pub. No.: US 2015/0151241 A1
(43) Pub. Date: Jun. 4, 2015

(54) PROCESS FOR THE HIGH TEMPERATURE SELECTIVE ABSORPTION OF HYDROGEN SULFIDE

(71) Applicant: SHELL OIL COMPANY, Houston, TX (US)

(72) Inventors: James Edward Critchfield, Austin, TX (US); Jingjun Zhou, The Woodlands, TX (US)

(21) Appl. No.: 14/402,435

(22) PCT Filed: May 29, 2013
(86) PCT No.: PCT/US2013/043110

§ 371 Date: Nov. 20, 2014

Related U.S. Application Data
(60) Provisional application No. 61/653,927, filed on May 31, 2012.

(51) Int. Cl. B01D 53/14

(52) U.S. Cl. CPC B01D 53/1493; B01D 53/1425; B01D 53/1468; B01D 2252/2026

(57) ABSTRACT

A high temperature selective absorption process for treating a gas stream having concentrations of both hydrogen sulfide and carbon dioxide to yield a treated gas stream having a reduced hydrogen sulfide concentration. The high temperature selective absorption process uniquely utilizes a novel absorbent composition which enables the processing of the gas stream under difficult absorption conditions and provides for other features of the inventive absorption process.

This invention relates to a process for the high temperature selective absorption of hydrogen sulfide from gaseous mixtures containing hydrogen sulfide and carbon dioxide.

The use of certain amine compounds and solutions for the separation of acidic gases such as CO₂, H₂S, CS₂, HCN, and COS from gaseous mixtures is known in the art of gas treating. One early method of separating acidic gases from gaseous mixtures is disclosed in U.S. Pat. No. 3,347,621. The process disclosed in this patent uses a liquid absorbent that comprises an alkanolamine and a sulfone that is contacted with a gas mixture containing acidic gas components. U.S. Pat. No. 3,965,244 and U.S. Pat. No. 3,989,811 are among other early patents that disclose the use of solutions of alkanolamine and sulfone in the treatment of gaseous mixtures that contain significant concentrations of H₂S, CO₂ and COS.

Certain specifically defined mixtures of severely hindered amine compounds that have been found to be useful in the selective absorption of hydrogen sulfide from gaseous fluids comprising hydrogen sulfide and carbon dioxide are disclosed in U.S. Pat. No. 4,894,178 and U.S. Pat. No. 4,961,873, and in other patents as well. In these patents, the disclosed absorbent compositions that include certain specifically defined severely hindered amine compounds are indicated to be particularly selective in absorbing hydrogen sulfide from fluids that comprise hydrogen sulfide as well as carbon dioxide. The teachings of these patents indicate a concern with providing absorption compositions having good H₂S selectivity, loading, and capacity characteristics rather than with providing an absorption composition having improved high temperature absorption properties or providing an absorption process for the high temperature selective absorption of hydrogen sulfide from gas streams containing hydrogen sulfide and carbon dioxide.

In typical gas treating absorption processes, a lean absorbent is introduced into an absorption column that provides for contacting the gas stream that is to be treated with the lean absorbent. Better absorption generally results when the contacting of the gas stream with the lean absorbent is done at the coolest feasible temperature. The absorption tends to be better at cooler temperatures which can be provided by various means of cooling the lean absorbent. The cooling of the lean absorbent may be provided, for example, by air or water cooled heat exchangers and by refrigeration systems.

There are many situations in which absorption gas treating systems are required to be operated under severe, high-temperature process conditions. For instance, in certain geographical regions of the world, the environmental conditions are such that there are limits to the effective use of air cooling. Also, cooling water availability and other means of cooling can additionally be limited. In these situations, refrigeration systems may be used, but they have the disadvantage of being costly and expensive to operate. Even under ideal conditions sometimes an absorption gas treating process may still require or benefit from the use of a refrigeration system used for cooling the lean absorbent prior to contacting it with the gas stream to be treated.

In addition to the capital costs and operating expenses associated with the use of systems for cooling the lean absorbent of a gas treating process, a treated gas that is yielded from the absorption column often can contain significant concentrations of the evaporated absorbent when the temperature conditions of the absorption step are high. The cost of the absorbent that is lost with the treated gas can be significant and such losses increase with increasing operating temperature of the absorption column. One means by which these absorbent losses are minimized is by the application of a system for the recovery of evaporated absorbent that is contained in the treated gas stream such as a water wash system.

It would be desirable to have an H₂S-selective gas treating process that includes an absorption contacting step which can operate under higher temperature conditions than is typical without having a significant loss of evaporated absorbent passing with the treated gas stream while still providing for a significant selective reduction of H₂S in the treated gas stream.

It further may be beneficial to have a high temperature absorption gas treating process that can operate without the need for lean absorbent refrigeration cooling systems to provide a cooled lean absorbent to the absorption column of the process. Also, it can be beneficial for such a high temperature absorption gas treating process to operate without the need for an absorbent recovery system to recover evaporated absorbent from the treated gas stream.

Accordingly, provided is process for the high temperature selective absorption of hydrogen sulfide from a gas steam, comprising hydrogen sulfide and carbon dioxide, wherein said process comprises: contacting, under a high temperature absorption condition, said gas stream with an absorbent composition that comprises an amination reaction product of a polydispersed polyethylene glycol (PEG) mixture and t-butylamine, wherein said polydispersed polyethylene glycol (PEG) mixture has an average molecular weight in the range of from 180 to 1000; and yielding a treated gas stream having a reduced hydrogen sulfide concentration.

Another embodiment of the process for the high temperature selective absorption of hydrogen sulfide from a gas stream, comprising hydrogen sulfide and carbon dioxide, comprises: introducing at a contacting temperature of greater than 50° C. an absorbent composition that is H₂S lean into a contacting column for contacting said absorbent composition that is H₂S lean with said gas stream; and yielding from said contacting column a treated gas stream having an amine concentration of said amination reaction product of less than 15 ppmv and an absorbent composition that is H₂S rich.

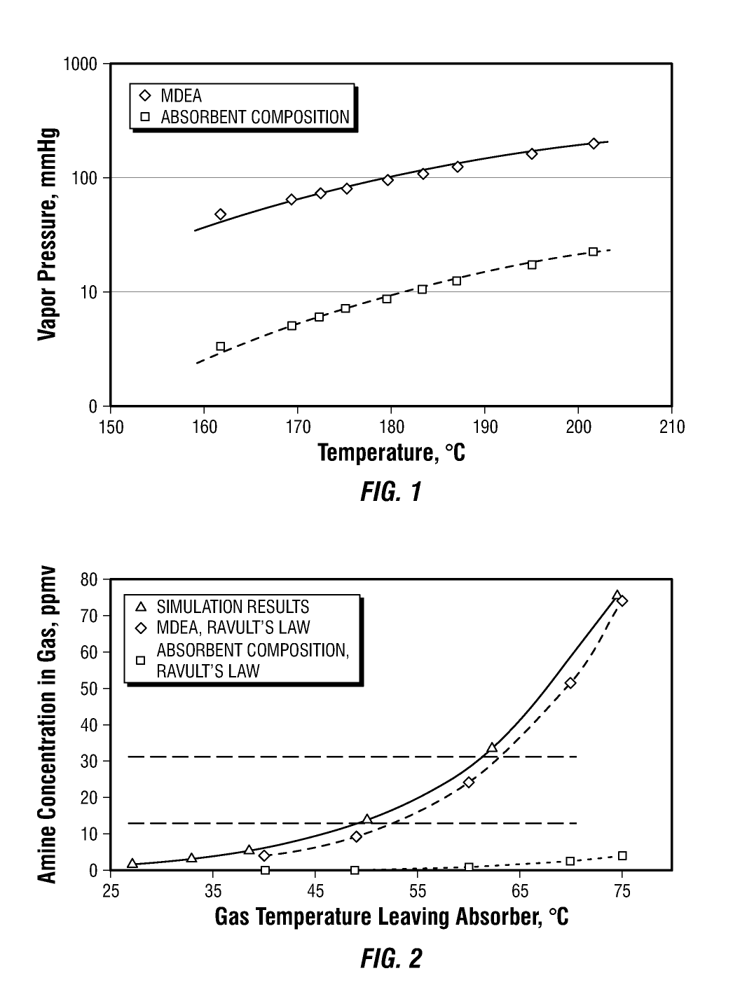

FIG. 1 are plots of vapor pressure date for the absorbent composition of the invention and for the prior art absorbent solvent, MDEA.

FIG. 2 are plots of the calculated absorbent (amine) concentration in a treated gas stream as a function of absorption treatment temperature for the case utilizing the absorbent composition of the invention and for the case utilizing the prior art absorbent solvent, MDEA.

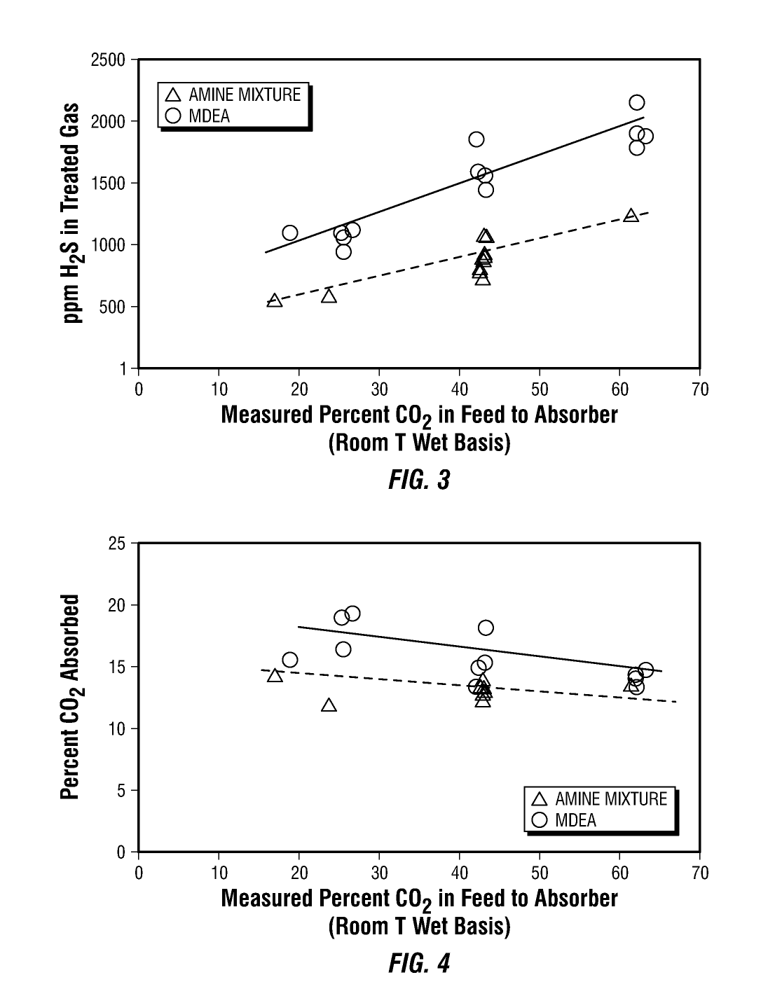

FIG. 3 presents plots of the measured H₂S concentration in a treated gas effluent from an absorber operated under a high temperature condition as a function of CO₂ contained in the gas to be treated as provided by an amine mixture of the invention and MDEA.

FIG. 4 presents plots of the percentage of the total CO₂ contained in the gas feed stream that is absorbed, under high temperature absorption conditions, by the amine mixture and by the MDEA.

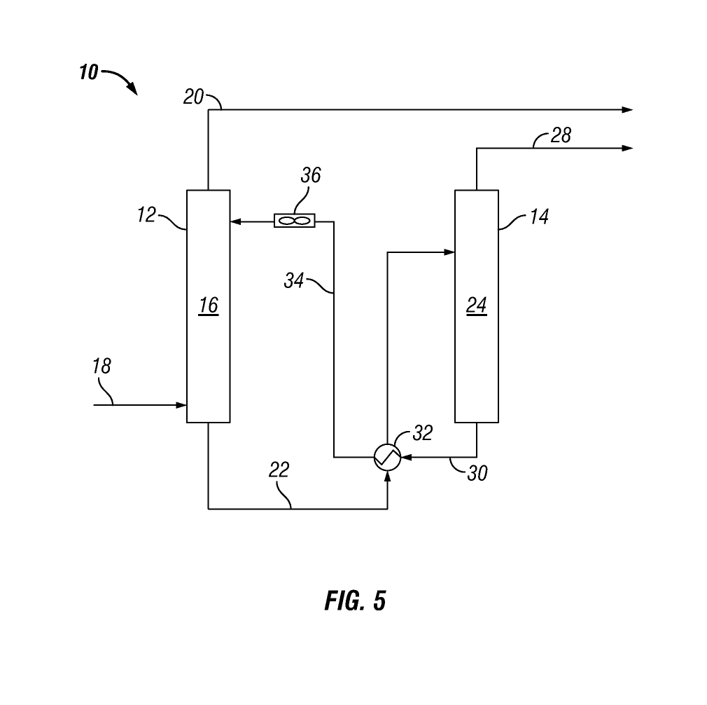

FIG. 5 is a simplified flow diagram of a gas absorption and regeneration process system utilizing a high temperature absorption process.

The process of the invention provides for the selective absorption of hydrogen sulfide from gas streams comprising hydrogen sulfide and carbon dioxide under unusually high absorption contacting temperature conditions to effectively yield a treated gas stream having a significantly reduced hydrogen sulfide concentration. The absorption contacting may also be done under relatively low absorption contacting pressure conditions. The effective selective H₂S absorption under these difficult absorption conditions of high temperature and low pressure are made possible by the use of a novel absorbent composition, as described in detail herein, that has certain properties which make it a highly H₂S selective absorbent even when it is used under high temperature absorption conditions.

The inventive process solves a number of problems that are often encountered in the operation of absorption gas treating operations in locations where useful water and air cooling of the absorbent is limited and refrigeration cooling is required. Due to the high temperature capabilities of the inventive process, refrigeration cooling costs associated with the operation of a gas absorption system can be reduced and, in some instance, even eliminated or avoided.

The inventive process further addresses the problem associated with the vaporization of the absorbent within the absorber-contactor when operated under a high temperature condition and it provides for a minimum of vaporized absorbent that passes with the treated gas stream when the absorber is operated under the difficult high temperature or low pressure, or both, conditions. This can result in eliminating the need for the installation or use of costly absorbent recovery systems for the recovery of evaporated absorbent in the treated gas stream.

The gas stream of the inventive process, which comprises hydrogen sulfide (H₂S) and carbon dioxide (CO₂), may be obtained from a wide variety of sources of gaseous mixtures. The gaseous mixtures can include the hydrocarbon-containing gases generated by processes involving pyrolysis of bituminous sands and hydrocarbon-containing gases produced or generated by refinery coker and cracking units and by other crude petroleum refinery operations. Natural gas streams having concentrations of acidic compounds, such as CO₂, H₂S, CS₂, HCN, and COS, can also be treated process.

The process also may be used to treat gas streams that contain very low concentrations of hydrocarbons and, even, no material concentration or substantially no concentration of hydrocarbons or otherwise having a material absence of hydrocarbons. One example of such a gas stream having a very low hydrocarbon concentration, if any, is a Claus unit tail gas stream.

Because one of the features of the inventive process provides for the selective absorption of H₂S relative to CO₂, even under severe absorption conditions, it is especially useful in the treatment of Claus tail gas streams. Claus tail gas streams typically have small concentrations of H₂S relative to their concentrations of carbon dioxide, but the H₂S concentrations tend to be too high to permit the streams from being combusted or released into the atmosphere. Therefore, it often is desirable to remove a substantial portion of the H₂S from the tail gas stream and to use the removed H₂S as a recycle feed to the Claus unit. However, it typically is not desirable to recycle CO₂ with the recovered H₂S to the Claus unit; because, the CO₂ loads up the unit by passing through it unchanged.

Claus unit tail gas streams typically can have an H₂S concentration that is in the range of from or about 0.2 vol. % (2,000 ppmv) to or about 4 vol. % (40,000 ppmv). More specifically, the H₂S concentration can be in the range of from 4,000 ppmv to 15,000 ppmv, and, even, from 6,000 ppmv to 12,000 ppmv.

The CO₂ concentration of the tail gas stream can sometimes range upwardly to 90 vol. % of the gas stream, depending upon the particular combustion gas that is used in the thermal step of the Claus unit. For instance, if a pure oxygen combustion gas is used in a thermal step of the Claus unit to burn the H₂S, there will be very little nitrogen in the tail gas and a very high concentration of CO₂. But, when air is used as the combustion gas, then the CO₂ concentration in the tail gas will be much lower and the N₂ concentration will be a significant component of the tail gas. Generally, the CO₂ concentration in the tail gas is considerably higher than its H₂S concentration, and the CO₂ concentration of the tail gas can be in the range of from 1 vol. % (10,000 ppmv) to 60 vol. %. More particularly, the CO₂ concentration is in the range of from 2 vol. % to 50 vol. % or from 3 vol. % to 40 vol. %.

In the typical case in which air is the combustion gas of the Claus unit thermal step, the tail gas stream includes a major portion that is molecular nitrogen (N₂), which typically is in the concentration range of from 40 to 80 vol. %.

The hydrocarbon-containing gas streams treated by the process can include in addition to the acidic components of H₂S and CO₂, the normally gaseous hydrocarbons, such as, for example, methane, ethane, and propane. The process is capable of treating gaseous mixtures wherein the components are present at concentrations within very wide ranges. For instance, the gaseous mixture to be treated can potentially contain H₂S at concentrations as high as 30 mole %, or even higher, and the mole ratio of CO₂ to H₂S can be in the range of from 0.1:1 to 10:1. The remaining balance of the gas stream can include normally gaseous hydrocarbons or nitrogen or other components or any combination thereof. An example of a gas stream that can be treated by the process may comprise H₂S at a concentration in the range of from about 0.1 vol. % (1,000 ppmv) to 20 vol. % with the CO₂ concentration being such that the mole ratio of CO₂ to H₂S is in the range of from 0.1:1 to 5:1.

In the process, a treated gas stream is yielded having a hydrogen sulfide concentration that is significantly reduced over the hydrogen sulfide concentration of the gas stream that is charged or introduced into the contactor or absorber of the process unit. This contacting or absorption step can be carried out by feeding the gas stream into the lower portion of an elongated contacting or absorption vessel that defines an absorption zone and provides means for contacting the gas stream with an absorbent composition that is H₂S lean. The absorbent composition that is H₂S lean is preferably introduced into the upper portion of the elongated contacting or absorption vessel and flows counter-currently with the gas stream to selectively remove H₂S therefrom. The contacting or absorption zone is typically equipped with contacting trays or packing or any other suitable means for promoting the contacting of the absorbent composition with the gaseous stream.

A particularly significant feature of the inventive process is the actual process conditions that are maintained within the contacting or absorption zone and at which the inventive process is carried out. The process is directed to a high temperature selective absorption of hydrogen sulfide from a gas stream and, therefore, the contacting or absorption conditions are more severe than are typically desired or even achievable with the use of conventional absorbent solvents. As is noted above, with use of conventional absorbent solvents, it is generally desired to conduct the absorption step at as low temperature as is feasible under the particular circumstances. In most conventional processes, it is desirable or necessary for the contacting or absorption temperature to be less than 50° C.

In the instant process, however, it is capable of operating under a high temperature absorption condition and still achieve good selective removal of hydrogen sulfide from the gas stream to yield a treated gas stream having a significantly reduced concentration of hydrogen sulfide over the H₂S concentration of the gas stream to be treated in spite of the high contacting temperature. Thus, the contacting temperature of the absorbent composition that is H₂S lean with the gas stream within the contacting or absorption zone can exceed 50° C. Typically, the contacting temperature range for the high temperature absorption condition is from 50° C. to or about 150° C. More typically, the high temperature absorption temperature can be in range of from 55° C. to 120° C., or it can be in the temperature range of from 60° C. to 110° C.

The contactor or absorber of the inventive process may also be operated under a low pressure absorption condition. While in conventional processes it can be desirable to carry out the absorption step under higher pressure conditions, one advantage of the inventive process is that it is capable of conducting its absorption step under both a low pressure absorption condition as well as under a high temperature absorption condition. This combination of difficult absorption conditions is unusual with conventional absorption processes that utilize conventional absorption solvents.

The low pressure absorption condition can be a pressure that is less than 1.4 bar (absolute). Thus, the absorption vessel may suitably be operated at a pressure in the range of from 0.3 bara to 1.4 bara. More typically, the pressure is in the range of from 1 bara to 1.3 bara, and, it can be in the range of from 1 bara to 1.25 bara.

One problem that is often encountered with operation of the absorber units of conventional absorption processes at higher contacting temperatures and at low contacting pressures is the resulting evaporation losses of the absorbent solvent. Typically, with the conventional absorption processes, when the contacting temperature exceeds around 50° C., significant fractions of the absorbent solvent are evaporated and pass with the treated gas stream thereby causing costly losses in the absorbent solvent. Low contacting pressures tend to make the problem with evaporative losses of the absorbent solvent even worst.

One solution to this problem is the use of an absorbent recovery system for recovering the evaporated absorbent solvent contained in the treated gas stream for return to and reuse in the absorption process. One example of such a system is a water wash system that is used to treat the treated gas stream in order to remove at least a portion of the evaporated absorbent solvent contained therein. The treatment of the treated gas stream is typically done prior to further processing of the treated gas stream such as by combustion or direct release into the atmosphere or by any other method.

The inventive process, however, can eliminate the need for the treatment of the treated gas stream by minimizing the amount of absorbent composition that passes with the treated gas stream. Thus, the inventive process further can provide for the absorption treatment of the gas stream under either a high temperature absorption condition or a low pressure absorption condition or under both high temperature and low pressure absorption conditions to provide a treated gas stream with a low concentration of the absorbent composition.

The treated gas stream of the inventive process may have a concentration of the evaporated absorbent composition in an amount that is less than 15 ppmv. More typically, the amount of the absorbent composition in the treated gas stream is less than 10 ppmv, and, it can even be less than 8 ppmv. It is most preferred for the treated gas stream to have a material absence of the evaporated absorbent composition but recognizing that a practical lower limit is about 1 ppmv. These concentration levels are such as to eliminate the need for the treatment of the treated gas stream to remove the absorbent composition prior to passing it downstream for further processing such as by combustion. Moreover, the absorption process is otherwise significantly more economical to operate under difficult absorption conditions of high temperature and low pressure due to the reduced evaporation losses of the absorbent composition as compared to prior art processes.

An essential feature of the inventive process is the utilization of a special absorbent composition that has unique properties which enable the operation of the process, as discussed above, under the difficult absorption conditions of high temperature and low pressure while still providing for the selective absorption of H₂S from a gas stream that comprises both H₂S and CO₂ to yield a treated gas stream having an exceptionally low H₂S concentration of less than 100 volume parts per million (ppmv), but, more specifically, an H₂S concentration of less than 50 ppmv. It is preferred for the concentration of H₂S in the treated gas stream to be less than 25 ppmv, and more preferred, it is less than 10 ppmv. A practical lower limit for the H₂S concentration of the treated tail gas is 1 ppmv, and, more typically, about 5 ppmv, but it is understood that it is generally desired for the treated gas steam to have the lowest concentration of H₂S as is possible.

### The Absorbent Composition

A necessary component of the absorbent composition of the invention is the mixture of amine compounds. In another embodiment, the absorbent composition can further comprise an aqueous solvent that includes the amine mixture and water.

The amine mixture component of the aqueous solvent and absorbent composition is an amination reaction product. The amination reaction product is prepared by the catalytic reaction, under suitable reaction conditions as more fully described elsewhere herein, of an amine compound that is, preferably, tert-butylamine, having the formula (CH₃)₃CNH₂, with polyethylene glycol, as represented by the following formula: HOCH₂(CH₂OCH₂)ₙCH₂OH, wherein n is an integer.

One of the attributes of the amine mixture, or amination reaction product, results from the characteristics of the polyethylene glycol (also referred to herein as “PEG”) reactant that is used in the preparation of the amine mixture. The PEG reactant does not consist of only a single PEG molecule, but it comprises more than a single PEG molecule.

Preferably, the PEG reactant used in the preparation of the amination reaction product is a mixture comprising two or more or a distribution of different PEG molecules having the aforementioned formula, wherein, for each of the individual PEG molecules, the integer n is a different value. Therefore, the amine mixture is not a reaction product of tert-butylamine and a single molecule of PEG, for example, triethylene glycol, but, instead, it is a reaction product of tert-butylamine with a distribution of PEG molecular compounds.

The mixture of PEG compounds used in preparing the amination reaction product typically includes two or more different PEG compounds having the aforementioned formula, wherein n is an integer selected from values in the range of from 1 to 24. It is preferred for the PEG mixture to comprise two or more molecules of the aforementioned formula, wherein the integer n is selected from the range of integers from 2 to 20, and, preferably from the range of integers from 2 to 18, and, most preferably, from the range of integers from 3 to 15.

The mixture of PEG compounds used as the reactant generally should have an average molecular weight in the range of from 180 to 1,000. Thus, the combination of individual PEG molecules and their relative concentrations in the mixture of PEG compounds used as a reactant in the preparation of the amination reaction product are such as to provide a mixture of PEG compounds having the indicated average molecular weight in the range of from 180 to 1,000. It is preferred for the PEG mixture used as a reactant in the preparation of the amination reaction product to have an average molecular weight that is in the range of from or about 180 to or about 400, and, more preferably, the average molecular weight is in the range of from 200 to 300.

The average molecular weight as used herein is the number average molecular weight as determined by measuring the molecular weight of each PEG molecule of the PEG mixture, summing the weights, and then dividing by the number of PEG molecules of the PEG mixture.

The amination reaction for preparing the amine mixture of the invention is carried out by contacting the reactants, i.e., tert-butylamine, PEG mixture, and hydrogen, with the amination catalyst of the invention under suitable amination reaction conditions to yield the amine mixture, i.e., the amination reaction product.

The selection of an amination catalyst for use in this catalytic reaction is important in providing an amine mixture having the properties and characteristics required of the invention. It is a combination of the characteristics and properties of the PEG reactant along with those of the amination catalyst used in the amination reaction that provides the unique amine mixture of the invention. Therefore, the composition and other characteristics of the amination catalyst can be an important if not a critical aspect of the invention.

The amination catalyst that is used in the preparation of the amine mixture contains catalytically active metal components, including, a nickel (Ni) component, a copper (Cu) component and either a zirconium (Zr) component or a chromium (Cr) component, or both, and, optionally, but preferably, a tin (Sn) component. It may be desirable in some instances for the amination catalyst to have a material absence of or substantial absence of or absence of such a metal as cobalt (Co), or tungsten (W) or molybdenum (Mo), or rhenium (Re) or any combination of one or more thereof. In certain other embodiments of the amination catalyst, it may have a material absence or substantial absence or absence of either zirconium or chromium, but not both metal components.

Possible amination catalyst compositions that may be used in preparing the amine mixture are disclosed and described in U.S. Pat. No. 4,152,353; U.S. Pat. No. 6,057,442; U.S. Pat. No. 7,196,033; and U.S. Pat. No. 7,683,007, the disclosures of which are incorporated herein by reference.

In a more specific embodiment of the invention, the amination catalyst comprises: from 40 to 90 wt. % nickel; from 4 to 40 wt. % copper; and from 1 to 50 wt. % of either zirconium or chromium, or a combination of both zirconium and chromium. The amination catalyst may further comprise, and preferably does comprise, from 0.2 to 20 wt. % tin.

The amination catalyst of the invention may be prepared by any of a variety of methods known to those skilled in the art to make a catalyst of the aforedescribed composition; provided, that such a catalyst may suitably be used in preparing the amine mixture of the invention. One example of a method of preparing the amination catalyst is by peptizing powdered mixtures of hydroxides, carbonates, oxides, or other salts of the metal (nickel, copper, zirconium, chromium, and tin) components with water in proportions so as to provide a composition as defined herein, and subsequently extruding and heat-treating the resulting composition.

The amination reaction may be conducted with any suitable reactor arrangement or configuration and under any suitable reaction conditions that provide for the desired amination reaction product. Examples of possible reactors for carrying out the amination reaction include fixed-bed reactors, fluid-bed reactors, continuous stirred reactors, and batch reactors.

The first sterically hindered amine is selected from the group of amine compounds having the following formula:

(CH₃)₃CNH(CH₂CH₂O)ₓCH₂CH₂NHC(CH₃)₃,

wherein x is an integer in the range of from 2 to 16, preferably, from 3 to 14.

The second sterically hindered amine is selected from the group of amine compounds having the following formula:

(CH₃)₃CNH(CH₂CH₂O)ₓCH₂CH₂OH,

wherein x is an integer in the range of from 2 to 16, preferably, from 3 to 14.

In certain embodiments of the invention, the weight ratio of first sterically hindered amine and second sterically hindered amine contained in the amine mixture can be in the range of upwardly to 10:1. In other cases, the amine mixture of the absorbent composition can have a weight ratio of the first sterically hindered amine to the second sterically hindered amine in the range of from 2.5:1 to 8:1, preferably, from 2.8:1 to 7:1, and, more preferably, from 3:1 to 6:1.

One particularly important physical property of the amine mixture of the absorbent composition is its low vapor pressure characteristic. The low vapor pressure characteristic of the amine mixture is one of the properties of the amine that provides for many of the special operating features of the inventive high temperature and low pressure selective absorption process. The amine mixture of the absorbent composition can have a vapor pressure at 200° C. of less than 30 mm Hg and at 150° C. of less than 10 mm Hg. More typically, and preferably, the vapor pressure of the amine mixture at 200° C. is less than 25 mm Hg and at 150° C. it is less than 5 mm Hg. The vapor pressure of the amine mixture is determined by any suitable standard method known to those skilled in the art for measuring vapor pressure of a liquid. One such method is mentioned in the Examples of this disclosure.

In one embodiment of the invention, the absorbent composition comprises the amine mixture, as described above, in combination with water to thereby provide or form an aqueous solvent that is a component of the absorbent composition.

The amine mixture component of the aqueous solvent is generally present in an amount in the range of from 20 wt. % to 70 wt. % and the water component is generally present in an amount in the range of from 30 wt. % to 80 wt. %. The weight percent values recited for these components are based on the total weight of the aqueous solvent or the amine mixture plus water.

It is preferred for the aqueous solvent to comprise from 25 wt. % to 65 wt. % amine mixture, or from 35 wt. % to 55 wt. % amine mixture. It is more preferred for the amine mixture to be present in the aqueous solvent in the range of from 40 wt. % to 50 wt. %.

The water content of the aqueous solvent can be in the preferred range of from 35 wt. % to 75 wt. %, or from 45 wt. % to 65 wt. %, and, more preferred, the water content is from 50 wt. % to 60 wt. %.

Reference now is made to FIG. 5 which presents a simplified flow diagram of a gas treating absorption/regeneration process system 10. Included in absorption/regeneration process system 10 are an absorber 12 and regenerator 14. Absorber 12 defines a contacting and absorption zone 16 and provides means for contacting an absorbent composition that is H₂S lean within the contacting and absorption zone 16 with a gas stream that is to be treated. The absorbent composition of the process is that as defined elsewhere herein in detail.

The contacting and absorption zone 16 of absorber 12 is operated under either a high temperature absorption condition or a low pressure absorption condition or a combination of both a high temperature and low pressure absorption conditions. A gas stream, which comprises both hydrogen sulfide and carbon dioxide, passes by way of conduit 18 and is introduced into the contacting and absorption zone 16 of absorber 12 wherein it is contacted with the absorbent composition that is H₂S lean under a high temperature absorption condition including, for example, a contacting temperature of greater than 50° C.

A treated gas stream is yielded and withdrawn from the contacting and absorption zone 16 of absorber 12 by way of conduit 20. The treated gas stream has a particularly low concentration of evaporated absorbent composition (amines of the amination product or amine mixture) that is less than 15 ppmv and has a significantly reduced concentration of hydrogen sulfide. The treated gas stream passes from absorber 12 to the downstream by way of conduit 20 for further processing (not labeled), such as by combustion, but without the prior treatment of the treated gas stream in order to remove a portion of the concentration of evaporated absorbent composition contained therein. Indeed, this is a particularly beneficial feature of the inventive process in that the concentration of the evaporated absorbent composition in the treated gas stream is low enough such that it does not need to be removed therefrom to permit its further processing.

The absorbent composition that is H₂S rich is yielded and withdrawn from the contacting and absorption zone 16 of absorber 12 by way of conduit 22 whereby it passes to regenerator 14. Regenerator 14 defines a regeneration zone 24 and provides means for regeneration of the absorbent composition that is H₂S rich. The absorbent composition that is H₂S rich is introduced into regeneration zone 24 of regenerator 14 from which is yielded and withdrawn stripped gases by way of conduit 28. A hot regenerated absorbent composition that is H₂S lean is yielded and withdrawn from regeneration zone 24 of regenerator 14 by way of conduit 30.

The hot regenerated absorbent composition that is H₂S lean passes by way of conduit 30 to feed/effluent heat exchanger 32, which defines a heat transfer zone and provides means for exchanging heat energy by indirect heat exchange between the absorbent composition that is H₂S rich and the hot regenerated absorbent composition that is H₂S lean to thereby provide a cooled regenerated absorbent composition that is H₂S lean.

The cooled regenerated absorbent composition that is H₂S lean then passes by way of conduit 34 and is introduced into the contacting and absorption zone 16 of absorber 12 at a high temperature. The cooled regenerated absorbent composition that is H₂S lean is used as the absorption composition that is H₂S lean. The cooled regenerated absorbent composition that is H₂S lean passes to absorber 12 without significant additional cooling, such as by refrigeration cooling, to thereby reduce the temperature below 50° C. Minor cooling, such as by the use of the illustrated fin fan cooler 36, may be used, but depending upon the environmental conditions, these types of heat exchanger devices may not provide significant cooling of the cooled regenerated absorbent composition that is H₂S lean.

The following examples are provided to illustrate certain embodiments of the invention, but they should not be considered as limiting the invention in any respect.

### EXAMPLE 1

This Example 1 presents the results of vapor pressure measurements of the absorbent composition, in an anhydrous form, of the invention and compares them with published vapor pressure data for anhydrous MDEA.

The absorbent composition of this example and the following examples was derived from an amination reaction product prepared by the catalytic reaction of tert-butylamine in the presence of an amination catalyst, as described herein, at a reaction temperature of 200° C. and a reaction pressure of 2,000 psig, with a polydispersed polyethylene glycol (PEG) mixture of an average molecular weight in the range of from 180 to 1000, and, in particular, a PEG mixture with an average molecular weight of about 240.

The vapor pressure of the absorbent composition was measured with an Ebulliometer at elevated temperature. The results of the vapor pressure measurements are presented in Table 1. Also presented in Table 1 for comparison is publically-available information for anhydrous MDEA taken from the DIPPR Database Diadem 2011. Plots of these data are presented in FIG. 1.

TABLE 1
Results of Vapor Pressure Measurements

| | Absorbent | MDEA |
|---|---|---|
| Temp° C. | mmHg | mmHg |
| 161.7 | 3.41 | 48.22 |
| 169.3 | 5.2 | 65.12 |
| 172.3 | 6.19 | 73.05 |
| 175.2 | 7.24 | 81.34 |
| 179.6 | 8.89 | 95.68 |
| 183.4 | 10.55 | 109.51 |
| 186.9 | 12.74 | 124.3 |
| 195.0 | 17.8 | 163.71 |
| 201.6 | 22.85 | 203.25 |

As may be seen from the data presented, the absorbent composition has an order of magnitude lower vapor pressure than the prior art absorption solvent, MDEA. This property of the absorbent composition of the invention advantageously provides for a significant reduction in absorbent losses when treating gas streams under difficult high temperature and low pressure absorption treatment conditions.

### EXAMPLE 2

### Calculated Example

This Example 2 is a calculated example intended to demonstrate the improvement in the operation of an absorption unit in the treatment of a gas stream under high temperature absorption conditions when using the absorbent composition of the invention versus using the prior art absorption solvent, MDEA.

Vapor losses of MDEA were estimated for an example tail gas treating unit. This example unit contained 21,300 pounds of installed inventory of amine. Volatility losses of MDEA were estimated assuming that example unit processed 7 MMscf per day of Claus tail gas. These losses were expressed as concentration of MDEA in the treated gas that resulted in the need to replenish a fixed percentage of the installed amine inventory, annually.

A commercial simulation tool, PROMAX v3.2, was used to estimate the concentration of MDEA that resulted in treated gas from an example tail gas unit operating. The treated gas from the absorber was at 1 psig pressure. The temperature of the lean amine feeding the absorber was varied, and the resulting concentration of MDEA in the treated gas was determined. The lean amine solution in the simulation contained 45 wt. % MDEA.

PROMAX v3.2 was also used to estimate the pure-component vapor pressure of MDEA at lower temperature. Raoult's Law was applied to this estimated vapor pressure, to create as second estimate of MDEA concentration in the treated gas leaving the top of the absorber.

Employing the observation from Example 1, that the absorbent composition has 1/10^{th} the vapor pressure of MDEA, an estimate of the concentration of the absorbent composition in the treated gas at the same conditions was prepared.

The results of these estimates are shown in the FIG. 2.

As may be seen from the plots presented in FIG. 2, the amine concentration in the treated gas for the high temperature absorption conditions (greater than 50° C.) is dramatically lower when the absorbent composition of the invention is used as opposed to when MDEA is used. Indeed, even with an absorber temperature condition of about 75° C., the amine losses to the treated gas with the use of the absorbent composition of the invention are lower than such losses that are associated with the use of the MDEA at a more typical absorber temperature of 40° C. This unique property of the absorbent composition permits the operation of a gas absorption process under a high temperature absorption condition without a significant loss in evaporated absorbent with the treated gas stream.

### EXAMPLE 3

This Example describes the procedure used to determine the performance of the absorbent composition and a comparative amine, MDEA, in the absorption removal under a high temperature absorption condition of hydrogen sulfide from a gas stream, and it presents the data resulting from this experiment.

A 45 wt. % solution of the absorbent composition of the invention was prepared and charged to a gas treating unit that comprised an absorber and a stripper connected together in a continuous flow loop. The lean absorbent temperature was controlled at a high temperature of approximately 70° C. while the stripper was heated to approximately 117° C. with stripping steam. A sour feed gas was prepared from cylinder gases containing H₂S, CO₂, and N₂ The gas flowrate of the gases was varied in order to supply gas to the absorber with the approximate concentration of 43% CO₂ and 6,000 ppm H₂S. The absorbent circulation flow was controlled and the circulation rate was varied from 110 ml/min to 180 ml/min. After approximately 4 hours of operation, the gas streams leaving the absorber and the stripper were analyzed by an online gas chromatograph. The volume of gas coming in and out of the absorber was also measured. The same procedures were repeated for a 45 wt. % MDEA.

Results are shown in FIG. 3 which plots the measured H₂S concentration in the treated gas effluent from the absorber that is operated under a high temperature absorption condition versus the CO₂ that is contained in the feed gas. The data show that the absorbent composition performs much better in scrubbing of H₂S from the gas feed under the high temperature absorption condition than does the prior art absorbent, MDEA.

### EXAMPLE 4

This Example describes the procedure used to determine the performance of the absorbent composition and a comparative amine, MDEA, in the high temperature absorption of carbon dioxide from a gas stream containing a concentration of carbon dioxide, and it presents data resulting from this experiment.

A 45 wt. % solution of the absorbent composition of this invention was prepared and charged to a gas treating unit that comprised an absorber and a stripper connected together in a continuous flowloop. The lean absorbent composition temperature was controlled at a high temperature of approximately 70° C. while the stripper was heated to approximately 117° C. with stripping steam. A sour feed gas was prepared from cylinder gases containing H₂S, CO₂, and N₂ The gas flow rate of the gases was varied in order to supply gas to the absorber at a specified CO₂ concentration (in the range of 0 to 65%) and H₂S concentration (approximately 6000 ppm). The absorbent circulation flow was controlled in the range of 110-120 ml/min. After approximately 4 hours of operation, the gas streams leaving the absorber and the stripper were analyzed by an online gas chromatograph. The volume of gas coming in and out of the absorber was also measured. The same procedures were repeated for 45% MDEA.

The results are shown in FIG. 4, which plots the percentage of the total CO₂ contained in the gas feed stream that is absorbed by the absorbent composition and by the MDEA. The data show that the absorbent composition absorbs less carbon dioxide under the high temperature absorption condition than does the MDEA. This is a desirable characteristic for the absorbent composition for cases in which the selective absorption of hydrogen sulfide over carbon dioxide is a desirable attribute.

1. A process for the high temperature selective absorption of hydrogen sulfide from a gas steam, comprising hydrogen sulfide and carbon dioxide, wherein said process comprises:
contacting, under a high temperature absorption condition, said gas stream with an absorbent composition that comprises an amination reaction product of a polydispersed polyethylene glycol (PEG) mixture and t-butylamine, wherein said polydispersed polyethylene glycol (PEG) mixture has an average molecular weight in the range of from 180 to 1000; and
yielding a treated gas stream having a reduced hydrogen sulfide concentration.

2. A process as recited in claim 1, wherein said high temperature absorption condition includes an absorber contacting temperature in the range of from 50° C. to 150° C.

3. A process as recited in claim 2, wherein said contacting further is conducted under a low pressure absorption condition that includes an absorber contacting pressure of less than 1.4 bara.

4. A process as recited in claim 3, wherein said absorbent composition has a vapor pressure at a temperature of 200° C. of less than 30 mm Hg.

5. A process as recited in claim 4, wherein said treated gas streams includes a concentration of evaporated absorbent composition of less than 15 ppmv.

6. A process as recited in claim 5, wherein said treated gas stream comprises a material absence of said amination reaction product.

7. A process for the high temperature selective absorption of hydrogen sulfide from a gas stream, comprising hydrogen sulfide and carbon dioxide, wherein said process comprises:
introducing at a contacting temperature of greater than 50° C. an absorbent composition that is H₂S lean into a contacting column for contacting said absorbent composition that is H₂S lean with said gas stream, wherein said absorbent composition comprises an amination reaction product of a polydispersed polyethylene glycol (PEG) mixture and t-butylamine, wherein said polydispersed polyethylene glycol (PEG) mixture has an average molecular weight in the range of from 180 to 1000; and
yielding from said contacting column a treated gas stream having an amine concentration of said amination reaction product of less than 15 ppmv and an absorbent composition that is H₂S rich.

8. A process as recited in claim 7, wherein said process further comprises:
further processing, such as by combusting, said treated gas stream without prior treatment of said treated gas stream to remove at least a portion of said amine concentration from said treated gas stream.

9. A process as recited in claim 8, wherein said process further comprises:
introducing said absorbent composition that is H₂S rich into a regenerator column providing for the regeneration of said absorbent composition that is H₂S rich; and
yielding from said regenerator column a hot regenerated absorbent composition that is H₂S lean.

10. A process as recited in claim 9, wherein said process further comprises:
exchanging heat by indirect heat exchange between said absorbent composition that is H₂S rich and said hot regenerated absorbent composition that is H₂S lean and providing a cooled regenerated absorbent composition that is H₂S lean.

11. A process as recited in claim 10, wherein said process further comprises:
utilizing said cooled regenerated absorbent composition that is H₂S lean without significant additional cooling to thereby reduce the temperature thereof below 50° C. prior to the introduction thereof into said contacting column as said absorbent composition that is H₂S lean.
